(19) United States
(12) Patent Application Publication
(10) Pub. No.: US 2010/0202738 A1
(43) Pub. Date: Aug. 12, 2010

(54) Structure and Method for Aligning an Optical Fiber and a Submicronic Waveguide

(75) Inventor: Christophe KOPP, Fontanil-Cornillon (FR)

Correspondence Address: VEDDER PRICE P.C., 222 N. LASALLE STREET, CHICAGO, IL, 60601, US

(73) Assignee: COMMISSARIAT A L'ENERGIE ATOMIQUE, Paris (FR)

(21) Appl. No.: 12/701,750

(22) Filed: Feb. 8, 2010

(30) Foreign Application Priority Data
Feb. 9, 2009 (FR) 09/50779

(51) Int. Cl. G02B 6/36

(52) U.S. Cl. 385/90

(57) ABSTRACT

A method for aligning an optical fiber and a submicronic waveguide of an integrated optical circuit, the waveguide including a core surrounded with upper and lower layers forming an optical cladding, including the steps of: (a) forming, in the upper layer, one or several openings capable of extracting light from the waveguide; (b) roughly positioning the optical fiber to send light into the waveguide; (c) finely moving the optical fiber with respect to the waveguide and detecting the position causing the extraction of a maximum amount of light at the level of the opening(s); and (d) depositing a glue binding the optical fiber to the optical circuit and filling the opening(s).

The present invention relates to an integrated optical circuit. More specifically, the present invention relates to a device and a method enabling to align an optical fiber and a submicronic waveguide of an integrated optical circuit.

Integrated optical circuits are being increasingly used in the field of telecommunications, especially for the transmission, processing, or storage of data. Integrated optical circuits may have many functions, such as multiplexing, demultiplexing, modulation, demodulation, spectral routing, amplification, accumulation, filtering, or a resonator function.

Integrated optical or optoelectronic circuits are generally formed in and on semiconductors wafers similar to those used in microelectronics. An integrated optical circuit comprises one or several elementary optical components processing one or several light beams, the light beams being conveyed between the elementary optical components by optical waveguides.

The integration of an increasing number of functions on same chip requires a miniaturization of integrated optical components and of the associated waveguides. When the waveguides have dimensions below one micrometer, one can speak of submicronic or nanometric waveguides. Currently, such waveguides may have cross-section areas on the order of 0.5×0.2 μm².

For medium and long-distance transmissions, that is, from a few meters to several kilometers, optical fibers are the privileged optical transport means. An optical fiber usable in the visible and close infrared range currently has a diameter ranging between 10 μm and a few tens of micrometers. It is accordingly necessary to use specific devices for coupling the optical fibers with the submicronic waveguides so that the light beams can travel correctly between these structures of different dimensions.

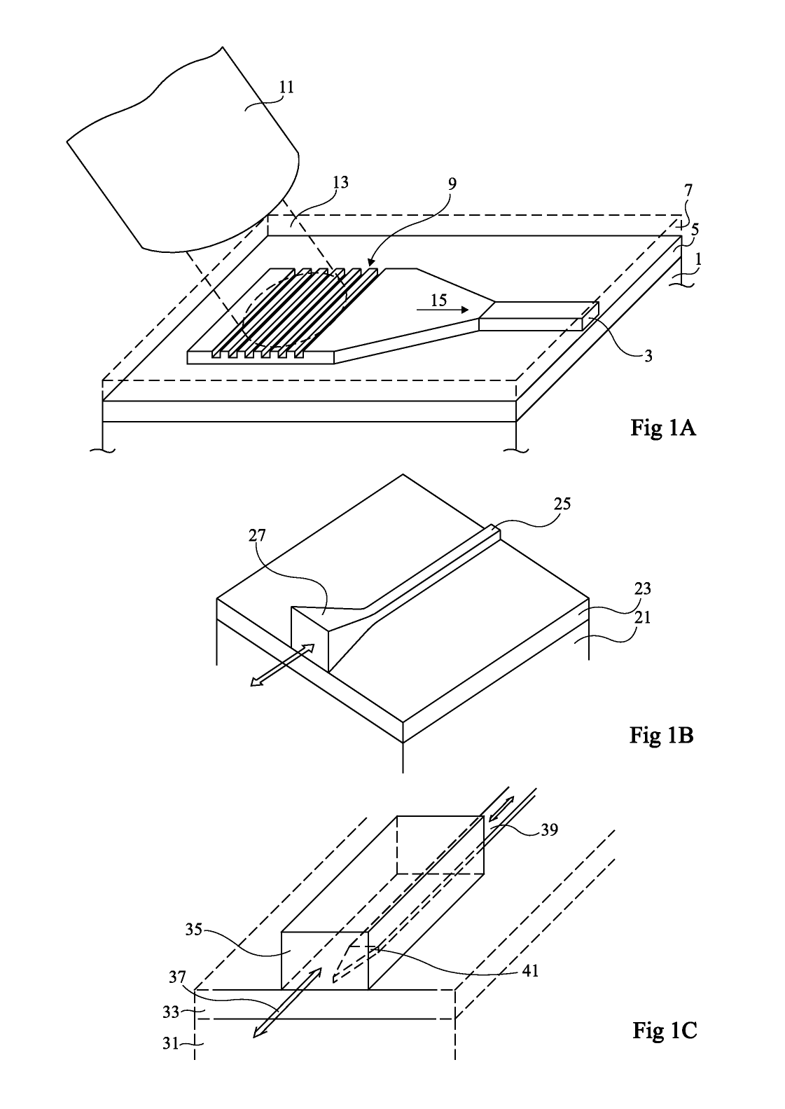

FIGS. 1A to 1C illustrate different known devices for coupling an optical fiber with a submicronic waveguide of an integrated optical circuit.

In FIG. 1A, above a support 1, for example, made of silicon, is formed a submicronic waveguide comprising a core 3 surrounded with lower and upper layers 5 and 7 of different indexes forming an optical cladding. Lower layer 5 and upper layer 7 are for example made of silicon oxide and core 3 is for example made of silicon. The optical index difference between the materials of the core and of the cladding of the waveguide enables to confine light beams within the core of waveguide 3.

A diffraction grating 9 is formed at the surface of core 3. Diffraction grating 9 is for example formed of an assembly of rectangular openings, parallel to one another. It may be provided, as shown, to widen the submicronic waveguide at the level of the diffraction grating to enable a better coupling. An optical fiber 11 having one of its ends placed in front of diffraction grating 9 delivers a light beam 13 towards diffraction grating 9. When optical fiber 11 properly illuminates diffraction grating 9 (good alignment), a light beam (arrow 15) travels through the waveguide. It should be noted that the structure of FIG. 1A may also be used to transmit a light beam originating from an integrated optical circuit to optical fiber 11 via the core of waveguide 3.

FIG. 1B shows a support 21, for example, made of silicon, on which extends a layer 23, for example, made of silicon oxide, forming a lower portion of an optical cladding. The core of a submicronic waveguide 25 extends on layer 23. It should be noted that the elements located above the core of waveguide 25, the upper layer of the optical cladding, for example, are not shown in FIG. 1B. The core of submicronic waveguide 25 widens, at the surface of layer 23, to form a wider region 27 above an edge of the structure. The coupling of an optical fiber and of the waveguide is obtained by alignment of the optical fiber on wider region 27. The narrowing of wide region 27 enables to progressively confine the light provided by the fiber within the core of waveguide 25. A device such as that of FIG. 1B is currently called a taper.

FIG. 1C is a perspective view illustrating an inverse taper structure.

The structure of FIG. 1C is formed on a silicon support 31 covered with a layer 33, for example, made of silicon oxide, forming a lower portion of an optical cladding. On layer 33 is formed the core of wide waveguide 35, for example, made of silicon oxide SiO_{X} having an optical index ranging between 1.6 and 1.8. Core 35 typically has a cross-section with dimensions on the order of a few micrometers, for example, a width of 3 μm and a height of 1 μm, and is intended to be illuminated (beam shown in FIG. 1C as an arrow 37) by an optical fiber from a first one of its ends substantially above an edge of support 31. The core of a submicronic waveguide 39, formed at the surface of layer 33, extends in the core of wide waveguide 35 and progressively narrows therein to form a tip 41 on the side of the first end of the core of wide waveguide 35. Core 39 and tip 41 may be made of silicon. It should be noted that a layer of appropriate index forming the upper portion of the optical cladding, not shown, and for example made of silicon oxide, extends over cores 35 and 39 of the waveguides to enable to confine light beams in these waveguides. In normal operation, a light beam having an adapted wavelength and biasing penetrating into the core of wide waveguide 35 travels through the core of submicronic waveguide 39.

For an optical circuit to operate properly and for the light to be coupled between an optical fiber and a submicronic waveguide of an integrated optical circuit, the optical fiber must be perfectly aligned with the coupling device which is associated thereto.

Several methods have been provided to perform this alignment. For example, the integrated optical circuit may be provided to deliver a light beam to the coupling device, and the alignment of the optical fiber is obtained when the amount of light that it conveys is maximum. It may also be provided to form a photodetector device in the integrated optical circuit to detect the position of the fiber enabling to convey the maximum light intensity towards the optical circuit.

However, such methods have the disadvantage of requiring the presence, in any integrated optical circuit, of elements dedicated to the alignment of the optical fibers, for example, illumination devices or photodetectors. Further, in the alignment, the integrated optical circuit must be in operation and thus requires a power supply.

There is a need for a device and a method enabling to align an optical fiber and a submicronic waveguide associated with an optical circuit, independently from the integrated optical circuit and from its operation.

An object of the present invention is to provide a method enabling to align an optical fiber and a submicronic waveguide associated with an integrated optical circuit.

An object of an embodiment of the present invention is to provide a method in which the elements enabling the alignment are neutralized once the alignment has been performed.

An object of an embodiment of the present invention is to provide a method requiring no additional steps with respect to known methods.

Thus, an embodiment of the present invention provides a method for aligning an optical fiber and a submicronic waveguide of an integrated optical circuit, the waveguide comprising a core surrounded with an upper and lower layer forming an optical cladding, the method comprising the steps of:

(a) forming, in the upper layer, one or several openings capable of extracting light from the waveguide;

(b) roughly positioning the optical fiber to send light into the waveguide;

(c) finely moving the optical fiber with respect to the waveguide and detecting the position causing the extraction of a maximum amount of light at the level of the opening(s); and

(d) depositing a glue binding the optical fiber to the optical circuit and filling the opening(s).

According to an embodiment of the present invention, the optical index of the glue ranges between 0.95 and 1.05 times the optical index of the upper layer.

According to an embodiment of the present invention, step (b) comprises positioning the optical fiber so that it illuminates an optical coupling device associated with the waveguide.

According to an embodiment of the present invention, the openings form a diffraction grating.

According to an embodiment of the present invention, the method further comprises a step of forming, in the upper layer, a cavity in contact with the openings, the glue being deposited in the cavity and penetrating into the diffraction grating by capillarity.

According to an embodiment of the present invention, a single opening with inclined walls is formed in the upper layer.

According to an embodiment of the present invention, the upper layer is made of silicon oxide, the core is made of silicon, and the glue has an optical index ranging between 1.40 and 1.48.

An embodiment of the present invention further provides an optical device comprising:

an optical fiber aligned with a submicronic waveguide of an integrated optical circuit, the waveguide comprising a core surrounded with upper and lower layers forming an optical cladding, the optical fiber being maintained in its position by a glue having an optical index ranging between 0.95 and 1.05 times the index of the upper layer; and

one or several openings formed in the upper layer, the opening(s) being filled with said glue.

According to an embodiment of the present invention, the upper layer is made of silicon oxide and the core is made of silicon.

According to an embodiment of the present invention, the openings form a diffraction grating in the upper layer.

The foregoing objects, features, and advantages of the present invention will be discussed in detail in the following non-limiting description of specific embodiments in connection with the accompanying drawings, among which:

FIGS. 1A to 1C, previously described, illustrate different known structures for coupling an optical fiber with a submicronic waveguide;

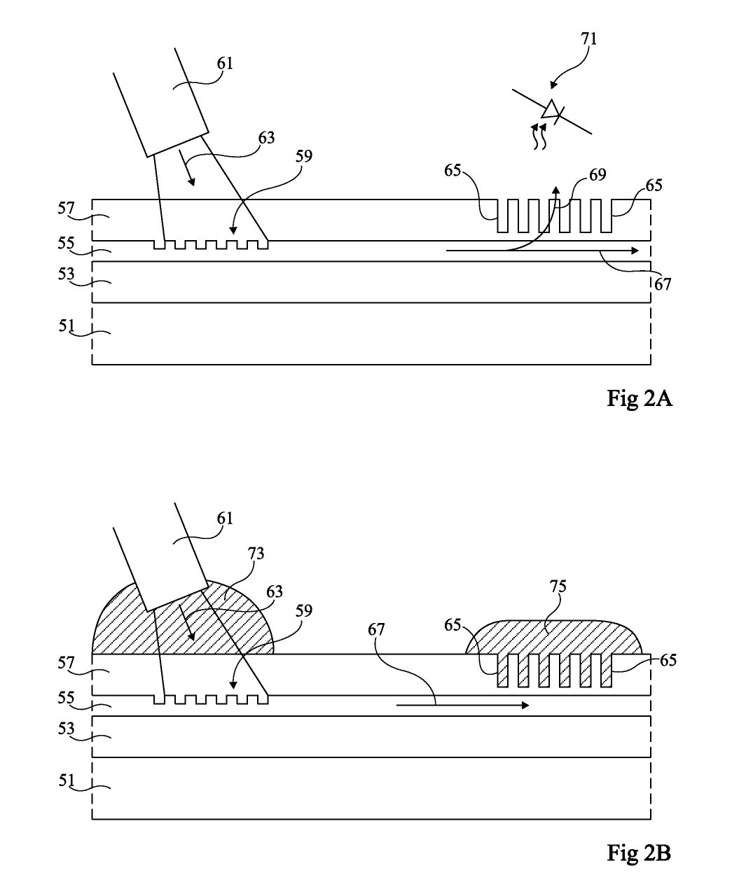

FIGS. 2A and 2B illustrate two steps of an alignment method according to an embodiment of the present invention; and

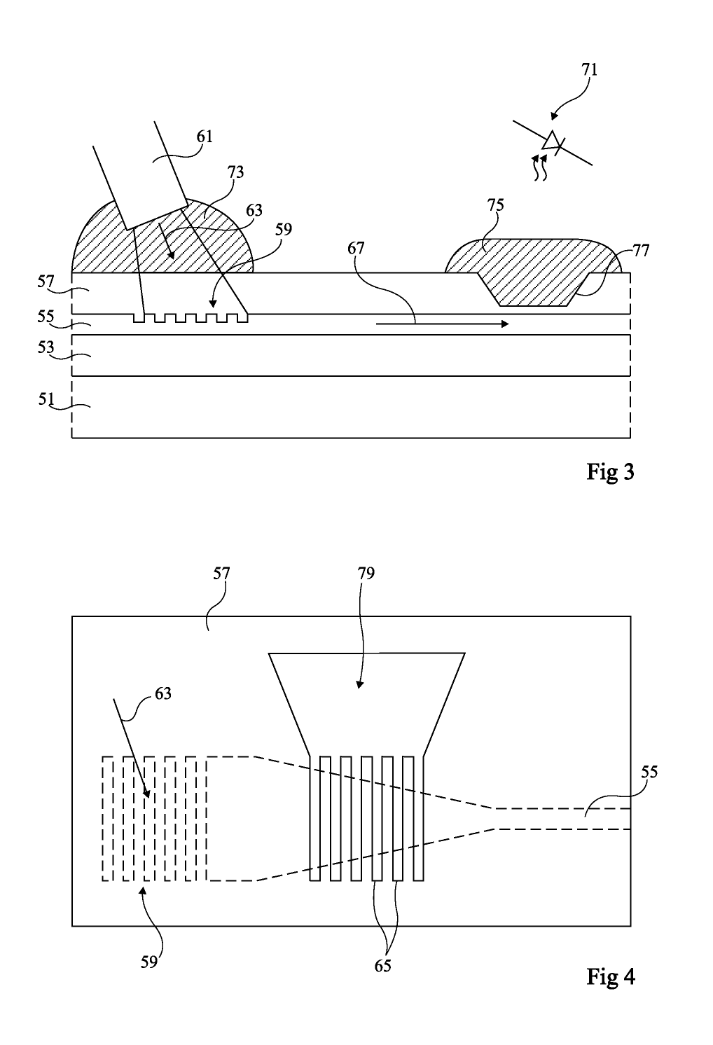

FIGS. 3 and 4 illustrate two variations of an embodiment of the present invention.

For clarity, the same elements have been designated with the same reference numerals in the different drawings and, further, as usual in the representation of integrated optical circuits, the various drawings are not to scale.

The present inventors provide a method enabling to align an optical fiber on a submicronic waveguide, which comprises a step of neutralization of the elements intended to perform the alignment, once said alignment has been completed.

FIGS. 2A and 2B illustrate two steps of a method for aligning an optical fiber on a submicronic waveguide.

In FIG. 2A, a device comprising a support 51, for example made of silicon, on which is formed a layer 53 which forming a lower layer of an optical cladding, is considered. On lower layer 53 is formed the core of a submicronic waveguide 55 surrounded and covered with a layer 57 forming an upper layer of the optical cladding.

In the following description, the different embodiments are described in relation with a structure comprising a device of coupling between the optical fiber and the submicronic waveguide formed of a diffraction grating. It should be noted that the method described herein may also apply to structures in which the coupling device is different from a diffraction grating, for example, a taper or an inverse taper. Further, it should be noted that, in the description, although the alignment is performed between the optical fiber and the coupling device, it is generally spoken of an alignment between the optical fiber and the submicronic waveguide.

At the surface of the core of submicronic waveguide 55 is formed a diffraction grating 59 which enables to couple an optical fiber 61 with the submicronic waveguide. Optical fiber 61 delivers a light beam 63 towards diffraction grating 59. Initially, optical fiber 61 is roughly positioned so that light beam 63 reaches the diffraction grating. The accurate alignment of optical fiber 61 and of diffraction grating 59 is performed in a subsequent step. Preferably, the end of the optical fiber is placed along a direction forming an angle ranging between 0° and 15° with respect to the direction perpendicular to the surface of upper layer 57.

Diffraction grating 59 may be formed of an assembly of parallel openings formed at the surface of the core of submicronic waveguide 55. Preferably, the core of submicronic waveguide 55 widens at the level of diffraction grating 59 to enable a good coupling between the optical fiber and the submicronic waveguide. As a variation, diffraction grating 59 may be formed of an assembly of metal strips, parallel to one another, formed at the surface of the wide portion of the core of submicronic waveguide 55.

At the surface of upper layer 57, preferably above the widened portion of the core of submicronic waveguide 55 or of the junction between this widened portion and the waveguide, are formed trenches 65. Trenches 65 extend in upper layer 57 all the way to the vicinity of the core of submicronic waveguide 55. The stopping of the trenches in upper layer 57 has the advantage of not altering the operation of the core of submicronic waveguide 55 once the alignment has been performed. However, it may also be provided to extend trenches 65 to contact the core of submicronic waveguide 55.

During the first step, optical fiber 61 is roughly aligned with diffraction grating 59 and a portion of light beam 63 is transmitted into the core of submicronic waveguide 55, via diffraction grating 59. This transmission is shown in FIG. 2A as an arrow 67. The presence of trenches 65 enables to extract a portion of the light from light beam 67 (arrow 69) towards the outside of the structure.

When the optical fiber is perfectly aligned with the diffraction network, the amount of light 67 transported in the core of optical waveguide 55 is maximum. The more light 67 is transported in the core of the submicronic waveguide, the more light 69 comes out of trenches 65.

Thus, the proper alignment of optical fiber 61 and of the submicronic waveguide directly depends on the amount of light 69 extracted from the core of waveguide 55 through trenches 65. To achieve an accurate alignment, a photodetector device 71, for example, a photodiode, is placed in front of wafers 65. Photodetector device 71 enables to determine the position of optical fiber 61 enabling to extract a maximum amount of light 69 and thus to have the best coupling with the submicronic waveguide.

FIG. 2B illustrates the result of a step carried out once the proper alignment of optical fiber 61 and of the diffraction grating 59 has been obtained. A glue 73 is deposited on the end of optical fiber 61 to enable to maintain it in its position. Glue 73 is made of a material having an optical index close to the optical index of upper layer 57, for example, ranging between 0.95 and 1.05 times this index. Thus, the glue has no influence upon the light beams travelling between the optical fiber and the submicronic waveguide.

Another dot of glue 75 is deposited in trenches 65. Advantageously, glue 75 is deposited during the same step as glue 73. Thus, since it is conventional to fix the optical fibers in position once their alignment has been performed, the method disclosed herein requires no additional steps with respect to known methods. Glue 75 penetrates from the upper surface of upper layer 57 into trenches 65, to fill them.

Thus, a structure comprising an optical fiber 61 properly aligned with a submicronic waveguide and in which trenches 65, filled with glue 75, no longer influence the device operation (no extraction of light 69). The device then operates normally, with no loss of light at the level of trenches 65, and the entire light beam coupled by diffraction grating 59 is transported by the core of submicronic waveguide 55 towards an integrated optical circuit. In other words, the extraction device used for the alignment is neutralized once the alignment has been performed.

As an example of numerical values, the end of optical fiber 61 closest to upper layer 57 is placed approximately 5 μm away from the surface of upper layer 57. Glue 73 is deposited across a thickness ranging between 10 μm and 20 μm so that the end of optical fiber 61 is properly held in its position. Lower layer 53 may have a thickness on the order of 2 μm, upper layer 57 may have a thickness of 0.5 μm, and the core of submicronic waveguide 55 may have a thickness on the order of 0.4 μm. Trenches 65 may have a period of the order of 0.5 μm with a 50% filling rate. Such dimensions of trenches 65 enable to perform an extraction of light 69 of approximately 0.5% of the light guided by the core of submicronic waveguide 55 for a light beam having a 1.55-μm wavelength.

The core of submicronic waveguide 55 may be made of silicon (optical index equal to 3.44) and lower and upper layers 53 and 57 may be made of silicon oxide (optical index equal to 1.44). To form this structure, any known substrate on insulator (SOI) may be used. Glue 73 and 75 may be made of any adhesive material having an optical index ranging between 1.40 and 1.48, for example, of epoxy, silicone, or acrylate.

FIGS. 3 and 4 illustrate two alternative embodiments of the method disclosed herein.

FIG. 3 illustrates a final step obtained from a variation in which the main elements of the device are identical to those of FIG. 2B. Trenches 65 are replaced with a single opening 77 formed in upper layer 57, above the core of submicronic waveguide 55. Preferably, the walls of opening 77 are inclined, the opening being flared towards the outside. At the final shown step, the alignment of optical fiber 61 has been completed and glue 75 has been deposited in opening 77 to fill it completely. This prevents the passing of a light beam coming from the core of submicronic waveguide 55 into opening 77. It should be noted that a single opening with inclined walls such as opening 77 enables to extract less light than an assembly of parallel openings such as trenches 65 of FIGS. 2A and 2B, but this will be sufficient in many cases.

FIG. 4 is a top view of a structure substantially identical to that of FIG. 2A. A light beam 63 coming from an optical fiber (not shown) illuminates a diffraction grating 59 formed at the surface of a widened potion of the core of a submicronic waveguide 55. Diffraction grating 59 and the core of submicronic waveguide 55 are covered with an upper layer 57. Trenches 65 are formed at the surface of upper layer 57. In the shown variation, a cavity 79 is formed, in upper layer 57, on one side of trenches 65 and contacts said trenches. Cavity 79 enables to help filling trenches 65 with glue 75. Indeed, for the deposition of glue 75, said glue is deposited in cavity 79 and, by capillarity, the glue penetrates into trenches 65 and fills them.

Specific embodiments have been described. Various alterations and modifications will occur to those skilled in the art. In particular, it should be noted that, although the coupling device shown in FIGS. 2A, 2B, 3, and 4 between the optical fiber and the submicronic waveguide is a diffraction grating, the method described herein may also be used in relation with other coupling devices, for example, a taper or an inverse taper. In the case of a taper, one or several openings will be provided, as described hereabove, one or several openings in the upper portion of the optical cladding surrounding the core of the submicronic waveguide. The only difference with the structures shown in relation with the drawings is that the optical fiber is aligned on one of the sides of the support comprising the submicronic waveguide, and thus that glue 73 is deposited on the edge of this support.

Further, structures similar to those disclosed herein may be formed by means of core and cladding materials different from those given as an example in the present description.

1. A method for aligning an optical fiber (61) and a submicronic waveguide of an integrated optical circuit, the waveguide comprising a core (55) surrounded with upper (57) and lower (53) layers forming an optical cladding, comprising the steps of:
(a) forming, in the upper layer (57), one or several openings (65; 77) capable of extracting light from the waveguide;
(b) roughly positioning the optical fiber (61) to send light into the waveguide;
(c) finely moving the optical fiber (61) with respect to the waveguide and detecting the position causing the extraction of a maximum amount of light at the level of the opening(s) (65; 77); and
(d) depositing a glue (73, 75) binding the optical fiber to the optical circuit and filling the opening(s) (65; 77).

2. The method of claim 1, wherein the optical index of the glue (73, 75) ranges between 0.95 and 1.05 times the optical index of the upper layer (57).

3. The method of claim 1, wherein step (b) comprises positioning the optical fiber so that it illuminates an optical coupling device (59) associated with the waveguide.

4. The method of claim 1, wherein the openings (65) form a diffraction grating.

5. The method of claim 4, wherein the method further comprises a step of forming, in the upper layer (57), a cavity (79) in contact with the openings (65), the glue (75) being deposited in the cavity and penetrating into the diffraction grating by capillarity.

6. The method of claim 1, wherein a single opening (77) with inclined walls is formed in the upper layer (57).

7. The method of claim 1, wherein the upper layer (57) is made of silicon oxide, the core (55) is made of silicon, and the glue (73, 75) has an optical index ranging between 1.40 and 1.48.

8. An optical device comprising:
an optical fiber (61) aligned with a submicronic waveguide of an integrated optical circuit, the waveguide comprising a core (55) surrounded with upper (57) and lower (53) layers forming an optical cladding, the optical fiber being maintained in its position by a glue (73) having an optical index ranging between 0.95 and 1.05 times the index of the upper layer (57); and
one or several openings (65; 77) formed in the upper layer (57), the opening(s) being filled with said glue (75).

9. The device of claim 8, wherein the upper layer (57) is made of silicon oxide and the core (55) is made of silicon.

10. The device of claim 8, wherein the openings (65) form a diffraction grating in the upper layer (57).
